(19) United States
(12) Patent Application Publication
(10) Pub. No.: US 2013/0050927 A1
(43) Pub. Date: Feb. 28, 2013

(54) COMPUTER CHASSIS CONSTRUCTION

(71) Applicant: QIANG CHAI, Shenzhen City (CN)

(72) Inventor: QIANG CHAI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/309,696

(22) Filed: Dec. 2, 2011

(30) Foreign Application Priority Data
Aug. 29, 2011 (CN) 201110250751.5

(51) Int. Cl. G06F 1/16

(52) U.S. Cl. 361/679.33

(57) ABSTRACT

A computer includes a hard disc; a motherboard; a chassis, a group of cables and the partition. The cables include a first end, a second end and a flexible cable portion between the first end and the second end. The hard disc and the motherboard are assembled in the chassis. The partition includes a planar body defining a first hole and a second hole, the first hole and the second hole positioned at opposite ends of the planar body. The first end of the cables is connected to the hard disc, the flexible cable portion extends through the first hole of the partition, and reversely extends through the second hole of the partition, the second end of the cables is connected to the motherboard.

### BACKGROUND

1. Technical Field

The present disclosure generally relates to a computer, and particularly to a computer chassis construction which has lower radiation emission.

2. Description of Related Art

Electronic components in a computer chassis are electrically connected to each other via cables. During the testing of radiation emission in the computer chassis, the arrangement of the electronic components and the positions of the cables greatly affect the radiation emission value of the computer chassis.

Therefore, there is room for improvement within the art.

### BRIEF DESCRIPTION OF THE DRAWINGS

Many aspects of the computer chassis construction can be better understood with reference to the following drawings. The components in the drawings are not necessarily to scale, the emphasis instead being placed upon clearly illustrating the computer chassis construction. Moreover, in the drawings, like reference numerals designate corresponding parts throughout the several views.

FIG. 1 is an isometric view of a computer chassis with a detached partition according to an exemplary embodiment.

FIG. 2 is an isometric view of the assembled computer chassis.

FIG. 3 is similar to FIG. 3, but shown from another aspect.

FIG. 4 is a test result graph of a radiation emission value of a conventional computer chassis.

FIG. 5 is a test result graph of a radiation emission value of the exemplary computer chassis.

FIG. 6 is a sampling data table of a conventional computer chassis.

FIG. 7 is a sampling data table of the exemplary computer chassis.

### DETAILED DESCRIPTION

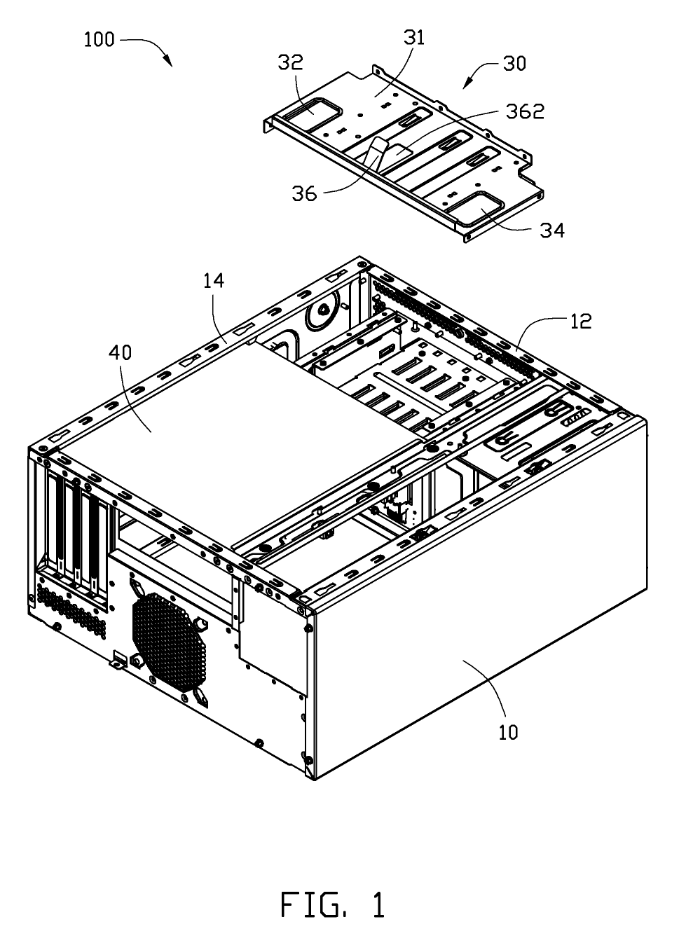

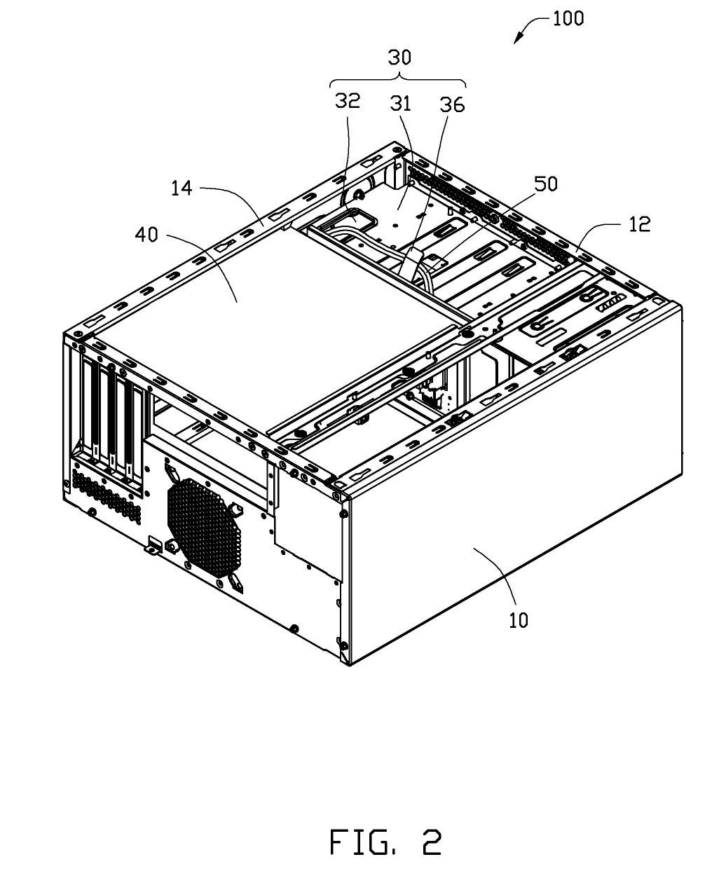

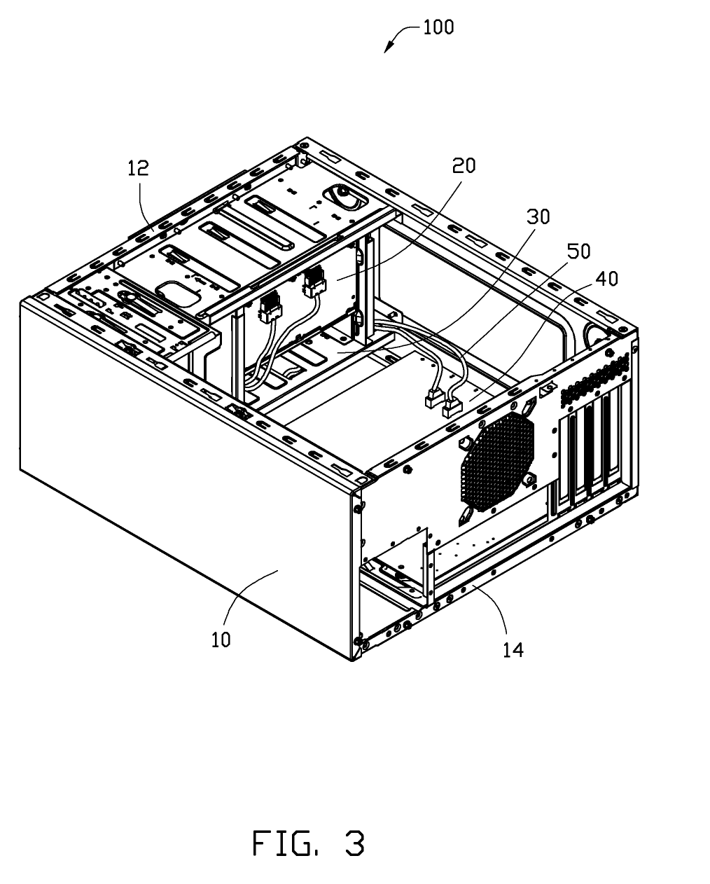

FIG. 1 to FIG. 3 shows an exemplary embodiment of a computer 100. The computer includes a chassis 10, a partition 30, and a group of cables 50. A hard disc 20, a motherboard 40, and other electronic components are assembled in the chassis 10. The chassis 10 includes a first frame 12 and a second frame 14 perpendicular to the first frame 12. The partition 30 is mounted on the first frame 12 and the second frame 14 for positioning the cable 50.

The partition 30 comprises a planar body 31 defining a first hole 32 and a second hole 34. The first hole 32 and the second hole 34 are positioned at opposite ends of the planar body 31. A latching tab 36 and a notch 362 are formed on the partition 30.

The hard disc 20 is mounted on the first frame 12 and the partition 30. The motherboard 40 is mounted on the second frame 14. The cables 50 include a first end, a second end and a flexible cable portion between the first end and the second end. The first end of the cables 50 is connected to the hard disc 20, the flexible cable portion extends through the first hole 32 of the partition 30, and reversely extends through the second hole 34 of the partition 30 , the second end of the cables 50 is connected to the motherboard 40. The tab 36 latches the flexible cable portion of the cable 50 on the partition 30. For reducing the radiation emission in the computer chassis 10, the partition 30 separates the flexible cable portion of the cables 50 from the hard disc 20.

The assembled computer 100 is tested by a known apparatus. The test apparatus is a spectrum analyzer (model No. E7405A) manufactured by Agilent Technology Co., Ltd. located in U.S.

To test the radiation emission of the computer 100, the computer 100 is placed on a worktable in a semi anechoic chamber, and the spectrum analyzer is placed outside of the semi anechoic chamber. The worktable is adjusted to 80 centimeters distanced from a ground. An antenna of the spectrum analyzer is placed in the semi anechoic chamber, and is spaced about 300 centimeters from the computer.

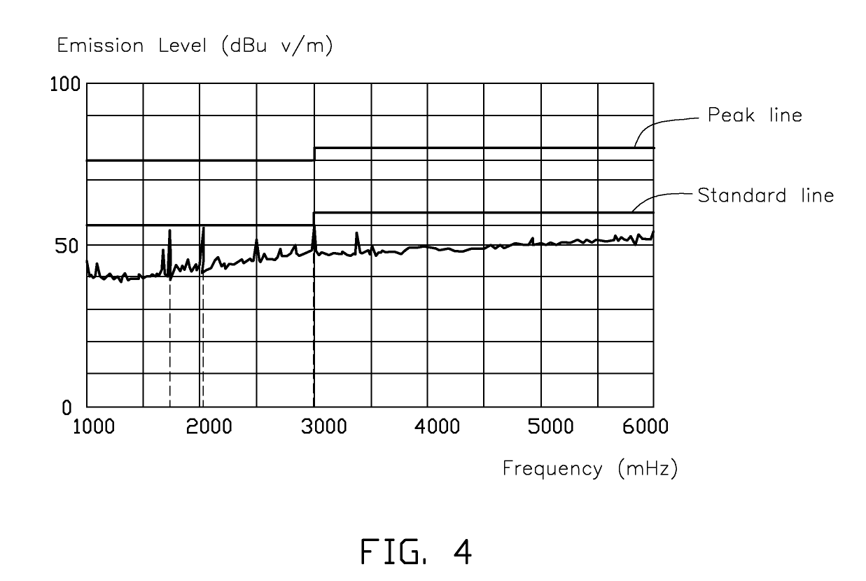

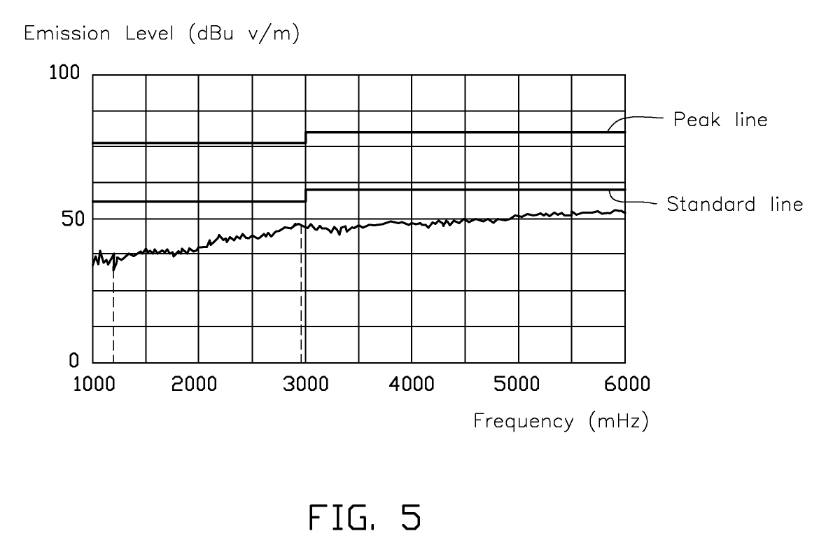

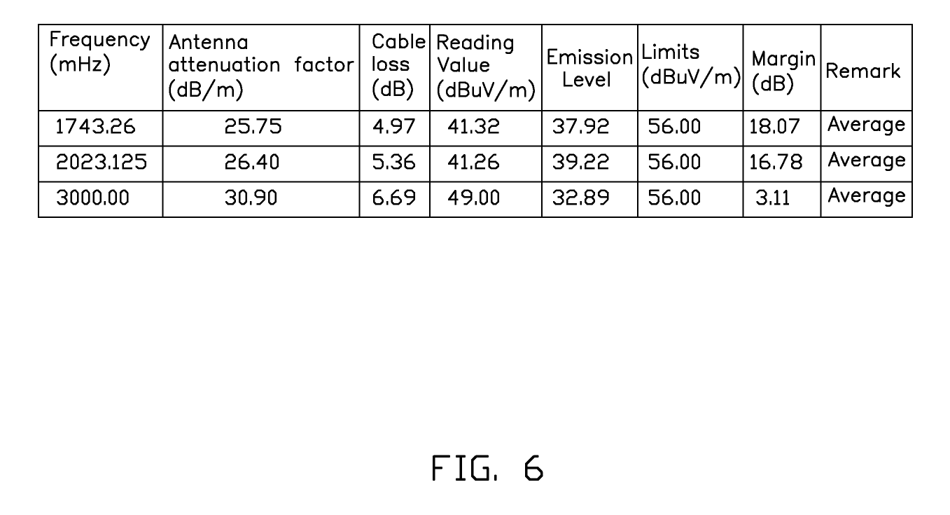

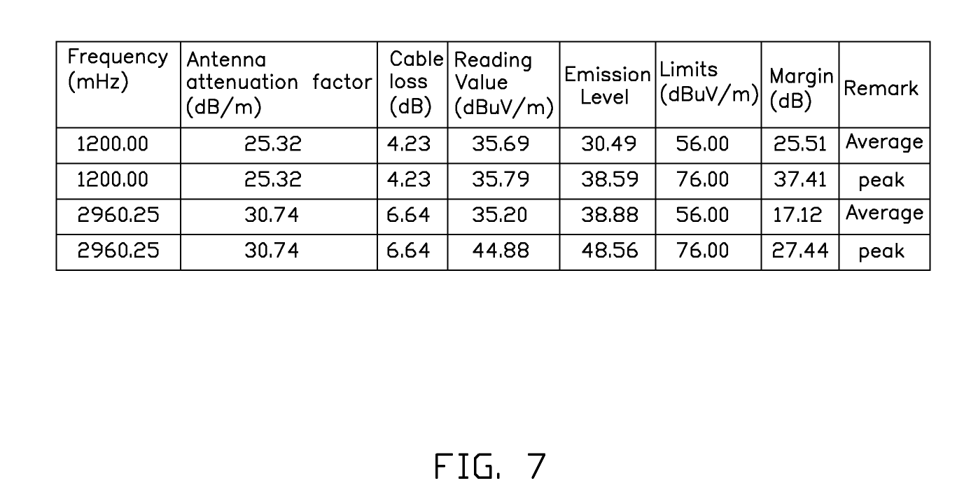

FIGS. 4 to 7 respectively show a test result of radiation emission. In FIGS. 4 and 6, the margin between the radiation emission value line and the standard line is very small for conventional computer chassis. In FIGS. 5 and 7, the margin between the radiation emission value line and the standard line is increased compared to FIGS. 4 and 6. It proves that the improved computer chassis reduces the radiation emission.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A computer comprising:
a hard disc;
a motherboard;
a chassis, the hard disc and the motherboard assembled in the chassis;
a group of cables including a first end, a second end and a flexible cable portion between the first end and the second end; and
a partition including a planar body defining a first hole and a second hole, the first hole and the second hole positioned at opposite ends of the planar body;
wherein the first end of the cables is connected to the hard disc, the flexible cable portion extends through the first hole of the partition, and reversely extends through the second hole of the partition, the second end of the cables is connected to the motherboard.

2. The computer as claimed in claim 1, wherein the chassis includes a first frame and a second frame perpendicular to the first frame, the partition is mounted on the first frame and the second frame for positioning the cables.

3. The computer as claimed in claim 2, wherein the hard disc is mounted on the first frame and the partition, and the motherboard is mounted on the second frame

4. The computer as claimed in claim 3, wherein a latching tab is formed on the partition for latching the cables.

5. The computer as claimed in claim 4, wherein the latching tab latches the flexible cable portion on the partition.

6. A computer comprising:
a hard disc;
a motherboard;
a chassis, the hard disc and the motherboard assembled in the chassis;
a cable including a first end, a second end and a flexible cable portion between the first end and the second end; and
a partition;
wherein the first end of the cable is connected to the hard disc, the flexible cable portion extends through the partition, and reversely extends through the partition, the second end of the cable is connected to the motherboard.

7. The computer as claimed in claim 6, wherein a latching tab is formed on the partition for latching the cable.
